(19) United States
(12) Patent Application Publication
(10) Pub. No.: US 2008/0101349 A1
(43) Pub. Date: May 1, 2008

(54) Module execution device

(76) Inventors: Masakazu Kanda, Kyoto (JP); Masaaki Tsujino, Nara (JP); Kunihiko Hayashi, Osaka (JP)

Correspondence Address: MCDERMOTT WILL & EMERY LLP, 600 13TH STREET, NW, WASHINGTON, DC, 20005-3096, US

(21) Appl. No.: 11/902,231

(22) Filed: Sep. 20, 2007

(30) Foreign Application Priority Data
Oct. 26, 2006 (JP) 2006-291373

(51) Int. Cl. H04L 12/50

(52) U.S. Cl. 370/360

(57) ABSTRACT

A module execution device includes: a module execution section for executing at least one of a control module and a controlled module generated by execution of the control module; inter-module communication sections of a plurality of types for performing inter-module communication between the control module and the controlled module; and an inter-module communication section selection section for selecting one of the inter-module communication sections which is to be used for the inter-module communication. The module execution device is configured so that at least one of the control module and the controlled module instructs the inter-module communication section selection section to select said one of the inter-module communication sections based on inter-module communication control information given from the outside of the control module or the controlled module.

### BACKGROUND OF THE INVENTION

The present invention relates to a module execution device configured so that inter-module communication between a control module and a controlled module generated and controlled by the control module.

### DESCRIPTION OF THE RELATED ART

Among devices in which various functions are realized by execution of programs, there are those in which a program is modularized and the modularized program is executed while inter-module communication is performed. Also, there are those in which when inter-module communication is performed, one of communication methods of a plurality of types is selectively used.

Specifically, for example, in a multi CPU system, when communication between modules (tasks) to be executed by the same CPU is performed, a message is directly transmitted. On the other had, when communication between tasks to be executed by different CPUs, a transmission request for specifying a communication destination task and a CPU which executes the destination task is given to an inter CPU communication task. In such a device, if a different CPU executes a communication destination task due to change of a system configuration or implantation into another system, a communication method is also changed, so that a task (modularized program) has to be modified and task reusability is reduced.

Then, for example, a technique for providing, in a device, a task table which is allocated at a time of system architecture is created and in which a task ID including a CPU number and a local task number is registered and a real time monitor which changes, with reference to the task table, a communication method according to whether a CPU for executing a communication destination task is the same as a CPU for executing a communication source task has been proposed (see, for example, Japanese Laid-Open Publication No. 8-339356). According to this technique, the same communication processing can be performed, despite which CPU executes the communication destination task.

### SUMMARY OF THE INVENTION

However, even when a device is configured such that a communication method is changed using a task table and a real time monitor in the above-described manner, a modularized program has to be modified to communicate with a different communication destination and task reusability tends to be reduced.

In view of the above-described point, the present invention has been devised and it is therefore an object of the present invention to increase reusability of a modularized program in a simple manner.

To achieve the above-described object, a module execution device according to one embodiment of the present invention includes: a module execution section for executing at least one of a control module and a controlled module generated by execution of the control module; inter-module communication sections of a plurality of types for performing inter-module communication between the control module and the controlled module; and an inter-module communication section selection section for selecting one of the inter-module communication sections which is to be used for the inter-module communication. In the module execution device, at least one of the control module and the controlled module instructs the inter-module communication section selection section to select one of the inter-module communication sections based on inter-module communication control information given from the outside of the control module or the controlled module.

Thus, a communication method used for inter-module communication is selected based on inter-module communication control information given from the outside of the control module or the controlled module. Therefore, a modularized program which is not affected by processing regarding communication procedures can be created and then used.

### BRIEF DESCRIPTION OF THE DRAWINGS

FIG. 1 is a block diagram illustrating a configuration of a module execution device according to an embodiment of the present invention.

FIG. 2 is a flowchart showing inter-module communication operation.

### DESCRIPTION OF THE PREFERRED EMBODIMENTS

A module execution device is configured, for example, by combining computer including a processor and a memory with an operating system, modularized programs and the like, and performs processing directed by the modularized programs.

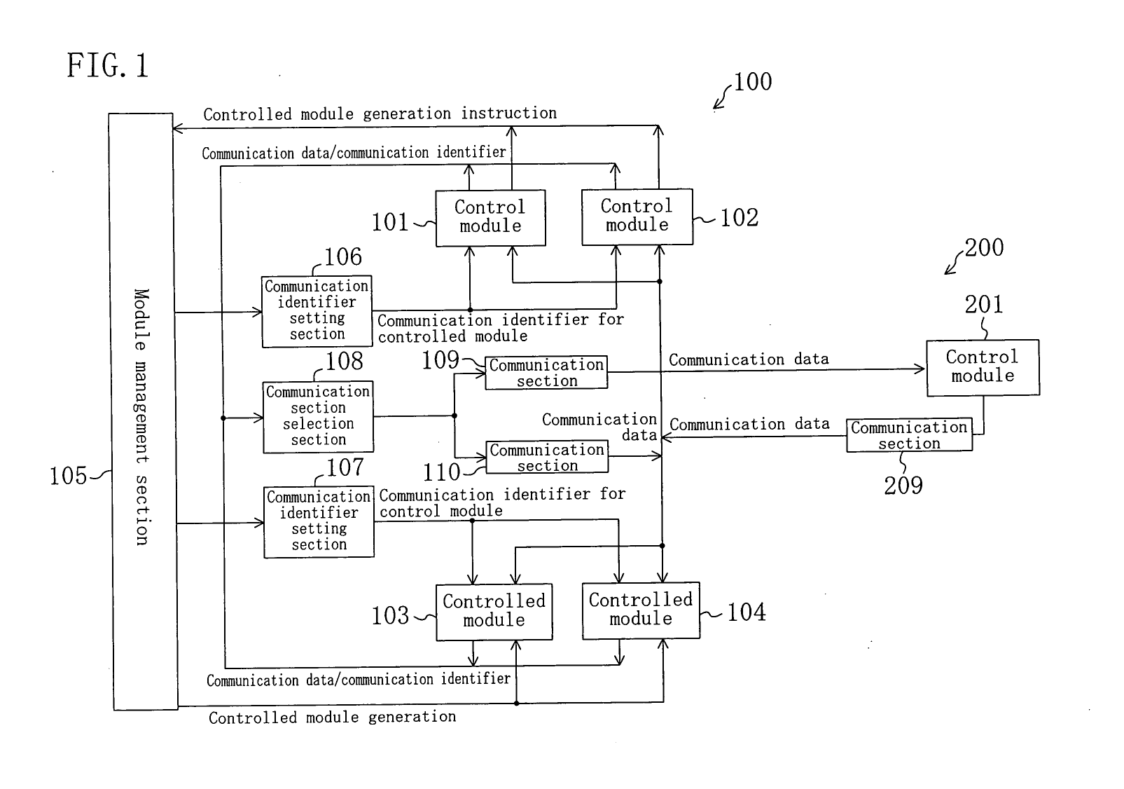

More specifically, a module execution device 100 has, for example, a functional configuration shown in FIG. 1.

Each of control modules 101 and 102 and controlled modules 103 and 104 is generated and executed (in other words, a modularized program is loaded and activated), thereby performing a predetermined processing. The contents of processing is not particularly limited but, for example, when the module execution device 100 is applied to a TV set and a video image recorder, each of the control modules 101 and 102 performs proprietary processing of a corresponding device and each of the controlled modules 103 and 104 performs processing for MPEG2 or MPEG4 or the like, which uses a common modularized program between the TV set and the video image recorder.

As an embodiment of such modules, for example, a thread in a multithread system, a task in a multi-task system may be used.

To distinguish between a control module and a controlled module, the relationship between a module generating another module and a module generated by another module is indicated. This distinction is relative and, for example, a controlled module may function as a control module to generate another controlled module.

A module management section 105 manages the generation of the controlled modules 103 and 104 and the like and generates the controlled modules 103 and 104 according to controlled module generation instructions from the control modules 101 and 102. In generating the controlled modules 103 and 104, communication identifier setting sections 106 and 107 are instructed to generate communication identifiers (inter-module communication control information) used for inter-module communication between each of the control modules 101 and 102 and an associated one of the controlled modules 103 and 104. The communication identifier includes, for example, a module number for specifying a communication destination module and a processor number of a processor which executes the module (in this embodiment, it is assumed that a module execution device and a processor are in the one-to-one correspondence). In this embodiment, the processor number literally specifies a processor and, in addition, is used as information indicating which one of communication sections 109 and 110 is used (i.e., which one of communication methods of plural types is used) as in the manner described later.

The communication identifier setting sections 106 and 107 generate communication identifiers according to instructions from the module management section 105 and perform setting for the modules 101 through 104 (so that each module can be referred to). Specifically, for example, each of the modules 101 through 104 is stored in a referable memory region or the like.

A communication section selection section 108 selects either one of the communication sections 109 and 110 according to a communication identifier given with communication data.

Each of the communication sections 109 and 110 performs processing for inter-module communication between modules. More specifically, the communication section 109 performs communication (inter-processor communication) from the modules 101 through 104 of the module execution device 100 to a control module 201 in a different module execution device 200. On the other hand, the communication section 110 performs communication (intra-processor communication) between the control modules 101 through 104 in the module execution device 100.

As the module management section 105, the communication identifier setting sections 106 and 107, the communication section selection section 108 and the communication sections 109 and 110, for example, controlled module generation processing, communication processing and the like which are generally provided as functions of an operating system can be used.

In FIG. 1, the module execution device 200 includes only the control module 201 and a communication section 209. However, the module execution device 200 may be formed so as to have the same configuration as that of the module execution device 100 or be formed so as to perform communication by a communication method specified in a modularized program in advance. That is, the module execution device 200 may be formed in any configuration as long as it can perform communication with each module in the module execution device 100.

The operation of the module execution device 100 having the above-described configuration will be described.

(Generation of the Controlled Module 103 by the Control Module 101)

For example, when the control module 101 instructs the module management section 105 to generate the controlled module 103, the module management section 105 loads a modularized program according to the instruction to start the modularized program, thereby generating the controlled module 103.

Also, the module management section 105 notifies the communication identifier setting section 106 of a module number of the generated controlled module 103 and a processor number of the module execution device 100 and the communication identifier setting section 107 of a module number of the control module 101 and a processor number of the module execution device 100. Then, each of the communication identifier setting sections 106 and 107 sets, for an associated one of the modules 101 and 103, a communication identifier including an associated one of the module numbers and an associated one of the processor numbers.

The controlled module 103 generated in the above-described manner is controlled by the control module 101 to perform predetermined processing and return a completion response for the processing and the like to the control module 101. The control and response are transmitted through inter-module communication.

(Communication from the Control Module 101 to the Controlled Module 103 or the Like)

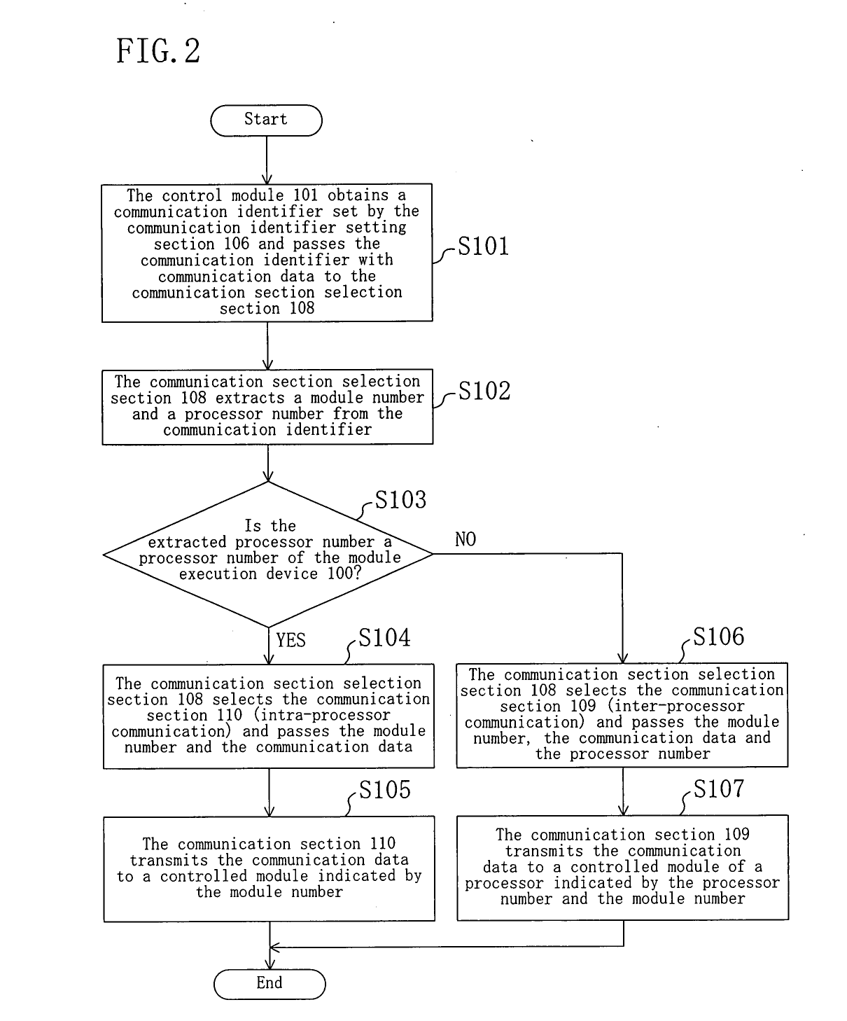

The above-described inter-module communication is performed, for example, in the manner shown in FIG. 2 and the following description.

(S101) The control module 101 obtains a communication identifier set by the communication identifier setting section 106 when the controlled module 103 is generated, i.e., a communication identifier including the module number of the controlled module 103 and the processor number of the module execution device 100 and passes the communication identifier with communication data to the communication section selection section 108.

(S102) The communication section selection section 108 extracts the module number and the processor number from the communication identifier.

(S103) The communication section selection section 108 judges whether or not the extracted processing number is the processor number of the module execution device 100.

(S104) When the controlled module 103 is a communication destination, the processor number matches. Accordingly, the communication section selection section 108 selects the communication section 110 (intra-processor communication) and passes the module number with the communication data to the communication section 110.

(S105) The communication section 110 transmits the communication data though intra-processor communication to the controlled module 103 or the like indicated by the module number.

If the control module 101 generates a controlled module executed by another processor and performs communication with the generated controlled module, it is judged in the above-described step (S103) that the processor number does not match, and the following processing is performed.

(S106) The communication section selection section 108 selects the communication section 109 (inter-processor communication) and passes the module number, the processor number and the communication data to the communication section 109.

(S107) The communication section 109 transmits communication data through inter-processor communication to the controlled module indicated by the processor number and the module number.

As described above, although a modularized program itself, which is a source of the control module 101, is coded without consideration of a communication method and a communication destination, communication processing based on a communication identifier set by the communication identifier setting section 106 is performed and communication with the controlled module 103 and the like can be properly performed.

Moreover, when the control module 101 performs communication with a controlled module generated by the control module 101, the control module 101 only has to obtain a communication identifier set by the communication identifier setting section 106 and do not need to refer to a task table for all tasks unlike Japanese Laid-Open Publication No. 8-339356. Therefore, a search time and a processing load can be reduced to increase the speed of processing in a simple manner. Also, increase in a memory usage amount is not caused.

(Communication from the Controlled Module 103 to the Control Module 101 or the Like)

In the same manner, for communication from the controlled module 103 to the control module 101, the communication section 110 is selected by the communication section selection section 108 based on a communication identifier set by the communication identifier setting section 107 and communication to the control module 101 is performed through intra-processor communication. That is, although a modularized program itself, which is a source of the controlled module 103, is coded without consideration of a communication method and a communication destination, communication processing based on a communication identifier set by the communication identifier setting section 107 is performed and thus communication with the control module 101 or the like can be properly performed.

Then, for example, even when the control module 102 generates the controlled module 104 based on the modularized program which is the source of the controlled module 103 and the controlled module 104 performs communication with the control control module 102, communication is also properly performed in the same manner based on a communication identifier set by the communication identifier setting section 107.

Furthermore, for example, when the control module 201 in the different module execution device 200 generates a controlled module in the module execution device 100, a communication identifier including a module number of the control module 201 and a processor number of the module execution device 200 is set for the controlled module. Accordingly, based on the communication identifier, communication from the controlled module to the control module 201 via the communication section 109 is properly performed.

Therefore, when controlled modules are generated by various control modules in the same module execution device or different module execution devices or when various communication methods are applied, without regard to actual communication destination and communication method, a modularized program for the controlled module having common communication procedures can be coded (without changing the description regarding communication processing) and can be used. Thus, either in the same equipment or among a plurality of equipment, reusability of a modularized program can be improved in a simple manner. Also, a modularized program can be made flexibly correspond to change of a system configuration in a simple manner.

When a module for which a communication identifier is set by the communication identifier setting section 107 in the above-described manner, i.e., a module to be, for example, a communication destination of the controlled module 103 is limited only to the control module 101 which has generated the controlled module 103, search for a task table is unnecessary and thus reduction in processing load and increase in processing speed can be achieved in a simple manner.

In the description above, an example in which two types of communication methods, i.e., inter-processor communication and intra-processor communication are used has been shown. However, communication methods are not limited thereto but intra-processor communication and inter-processor communication according to plural types of interfaces and protocols may be selectively used. Specifically, even when a communication method is determined (changed) according to various conditions in the same processor or among different processors, a modularized program can be also used without changing the description regarding communication processing and independency and reusability can be improved.

The example in which a communication identifier includes a module number and a processor number of a communication destination and a communication method is selected according to the processor number has been described. However, a communication identifier is not limited thereto but information directly indicating a communication method may be included in the communication identifier.

For example, a communication identifier may include a processor number and a communication method number to indicate inter-processor communication or intra-processor communication by the processor number and also indicate a communication method in each module by the communication method number. A combination of inter-processor communication or intra-processor communication and a communication method may be indicated by the communication method number or the like.

Furthermore, for example, when a single processor is provided, on the assumption of use of intra-processor communication, a communication identifier may be configured so as not to include a processor number.

For the sake of simplification, the description has been made assuming that a module execution device and a processor are in the one-to-one correspondence. However, the relationship between a module execution device and a processor is not limited thereto but, for example, a multi-processor configuration in which a single module execution device includes processors of the same type or of different types may be used.

The example in which setting for a communication identifier is done when a controlled module is generated has been described. However, when a controlled module to be generated is determined in advance, setting for a communication identifier may be done at the time of system construction or the like.

As has been described, according to the present invention, a communication method can be flexibly selected based on inter-module communication information, so that a modularized program can be reused without changing the program.

What is claimed is:

1. A module execution device comprising:
a module execution section for executing at least one of a control module and a controlled module generated by execution of the control module;
inter-module communication sections of a plurality of types for performing inter-module communication between the control module and the controlled module; and
an inter-module communication section selection section for selecting one of the inter-module communication sections which is to be used for the inter-module communication,
wherein at least one of the control module and the controlled module instructs the inter-module communication section selection section to select said one of the inter-module communication sections based on inter-module communication control information given from the outside of the control module or the controlled module.

2. The module execution device of claim 1, wherein when a control module generates a controlled module, inter-module communication control information according to communication between the control module and the controlled module is generated.

3. The module execution device of claim 2, wherein each time when a control module generates a controlled module, intra-module communication control information according to communication from the control module to the controlled module is generated and the control module can perform communication with a plurality of controlled module generated by the control module.

4. The module execution device of claim 2, wherein the module execution device is configured that when a control module generates a controlled module, inter-module communication control information corresponding to communication from the controlled module to the control module and the controlled module can perform communication with the control module which has generated the controlled module.

5. The module execution device of claim 1, wherein each of the inter-module communication sections of a plurality of types includes an inter-module communication section for performing communication between modules executed by the same processor and an inter-module communication section for performing communication between modules executed by different processors, the inter-module communication control information includes processor specifying information indicating a processor which executes a module of a communication destination, and said one of the inter-module communication sections is selected based on the processor specifying information.

6. The module execution device of claim 1, wherein the inter-module communication control information includes module specifying information for specifying a module of a communication destination and processor specifying information indicating a processor which executes the module of the communication destination, and inter-module communication between the control module and the controlled module is performed based on the inter-module communication control information.

7. A recording medium in which a modularized program indicating processing contents of a control module or processing contents of a controlled module generated by execution of the control module is recorded, wherein based on inter-module communication information given from the outside of the control module or the controlled module, an inter-module communication method used for inter-module communication between the control module and the controlled module is selected.
